(19) United States
(12) Patent Application Publication
(10) Pub. No.: US 2019/0027796 A1
(43) Pub. Date: Jan. 24, 2019

(54) INTERDIGITATED 2-D POSITIVE TEMPERATURE COEFFICIENT DEVICE

(71) Applicant: Littelfuse, Inc., Chicago, IL (US)

(72) Inventors: Yuriy B. Matus, Pleasanton, CA (US); Martin G. Pineda, Fremont, CA (US); Chun-Kwan Tsang, Morgan Hill, CA (US)

(73) Assignee: Littelfuse, Inc., Chicago, IL (US)

(21) Appl. No.: 15/654,860

(22) Filed: Jul. 20, 2017

(51) Int. Cl. H01M 10/637; H01M 10/42; H02H 7/18

(52) U.S. Cl. CPC H01M 10/637; H01M 10/425; H01M 2010/4271; H01M 2200/106; H02H 7/18

(57) ABSTRACT

Provided herein are positive temperature coefficient (PTC) devices including interdigitated contacts. In one approach, a PTC device includes a core component, and a first contact and a second contact disposed along a first side of the core component. Each of the first and second contacts may include a frame member, and a plurality of digits extending perpendicularly from the frame member. The plurality of digits of the first contact may be interleaved with the plurality of digits of the second contact. In some embodiments, the plurality of digits of the first contact and the plurality of digits of the second contact extend along a same plane, and are arranged substantially parallel to one another. In some embodiments, a polymer PTC material layer is provided over the plurality of digits of the first and second contacts. The interleaved contact digits permit the PTC device to function as a 2-D current collector.

### FIELD OF THE DISCLOSURE

The disclosure relates generally to battery protection devices, and more particularly, to a positive temperature coefficient (PTC) device including interdigitated contacts.

### BACKGROUND OF THE DISCLOSURE

With rapid development of the electronic, communication and computer industries, there is an increasing use of portable electronic devices. Many portable electronic devices employ secondary (e.g., rechargeable) batteries as power sources. Batteries, such as lithium batteries, are sensitive to faults caused by external short circuits, uncontrolled charging, abuse of over-charging, and the like. In order to provide an over-temperature or over-current protection for a battery cell, various protection devices have been developed. One such protection device includes a positive temperature coefficient (PTC) device, which may contain PTC elements such as a PTC conductive polymer, e.g., a composition comprising an organic polymer and, dispersed or otherwise distributed therein, a particulate conductive filler, e.g., carbon black, or a metal or a conductive metal compound. Such devices may be referred to as polymer PTC, or PPTC resistors or resistive devices.

PTC devices subscribe to the trend of increasingly smaller size and higher integration density. Therefore, how to decrease device thickness, while maintaining device integrity and reliability, is a critical problem to be addressed.

### SUMMARY

In view of the foregoing, what is needed is a positive temperature coefficient (PTC) device including interdigitated contacts, which deliver current primarily in an orthogonal direction, thus decoupling device thickness from electric field strength of the PTC material and provides basic unit cell or device for flexible or conformal PTC.

In one approach, a surface mounted device according to embodiments of the disclosure may include a core component, and a first contact and a second contact disposed along a first side of the core component. Each of the first and second contacts may include a frame member and a plurality of digits extending from the frame member, wherein the plurality of digits of the first contact are interleaved with the plurality of digits of the second contact.

In another approach, a positive temperature coefficient (PTC) device according to embodiments of the disclosure may include a core component, and a first contact and a second contact disposed along a first side of the core component. Each of the first and second contacts may include a frame member and a plurality of digits extending substantially perpendicularly from the frame member, wherein the plurality of digits of the first contact are interleaved with the plurality of digits of the second contact.

In yet another approach, a method for forming a surface mounted device according to embodiments of the disclosure may include providing a core component on a substrate, and providing a first contact and a second contact along a first side of the core component. Each of the first and second contacts may include a frame member, and a plurality of digits extending from the frame member, wherein the plurality of digits of the first contact are interleaved with the plurality of digits of the second contact.

### BRIEF DESCRIPTION OF THE DRAWINGS

The accompanying drawings illustrate approaches of the disclosed embodiments so far devised for the practical application of the principles thereof, and in which:

FIG. 1 is an isometric view of a device, such as a surface mounted PTC device, according to an approach of the disclosure;

FIG. 2 is side view of the device of FIG. 1 according to an approach of the disclosure;

FIG. 3 is a partially exploded view the device of FIG. 1 including one or more PPTC material layers according to an approach of the disclosure;

FIG. 4 depicts a top view of the device of FIG. 3 according to an approach of the disclosure;

FIG. 5 depicts a side view of the device of FIG. 3 according to an approach of the disclosure;

FIG. 6 depicts a side view of the device of FIG. 3 including a bonding layer according to an approach of the disclosure;

FIGS. 7A-B depict various surface mounted PCT devices according to an approach of the disclosure;

FIG. 7C depicts a schematic of the device of FIG. 7A according to an approach of the disclosure; and

FIG. 8 depicts a method of forming a PTC device according to an approach of the disclosure.

The drawings are not necessarily to scale. The drawings are merely representations, not intended to portray specific parameters of the disclosure. The drawings are intended to depict typical embodiments of the disclosure, and therefore should not be considered as limiting in scope. In the drawings, like numbering represents like elements.

Furthermore, certain elements in some of the figures may be omitted, or illustrated not-to-scale, for illustrative clarity. Furthermore, for clarity, some reference numbers may be omitted in certain drawings.

### DETAILED DESCRIPTION

Embodiments in accordance with the present disclosure will now be described more fully hereinafter with reference to the accompanying drawings. The system/circuit may be embodied in many different forms and should not be construed as being limited to the embodiments set forth herein. Rather, these embodiments are provided so that this disclosure will be thorough and complete, and will fully convey the scope of the system and method to those skilled in the art.

For the sake of convenience and clarity, terms such as “top,” “bottom,” “upper,” “lower,” “vertical,” “horizontal,” “lateral,” “longitudinal,” “above,” and “below” will be used herein to describe the relative placement and orientation of various components and their constituent parts. Said terminology will include the words specifically mentioned, derivatives thereof, and words of similar import.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

As stated above, provided herein are positive temperature coefficient (PTC) devices including interdigitated contacts. In one approach, a PTC device includes a core component, and a first contact and a second contact disposed along a first side of the core component. Each of the first and second contacts may include a frame member, and a plurality of digits extending perpendicularly from the frame member. The plurality of digits of the first contact may be interleaved with the plurality of digits of the second contact. In some embodiments, the plurality of digits of the first contact and the plurality of digits of the second contact extend along a same plane, and are arranged substantially parallel to one another. In some embodiments, a polymer PTC material layer is provided over the plurality of digits of the first and second contacts. The interleaved contact digits permit the PTC device to function as a 2-D current collector.

Furthermore, although not described in detail herein, the PTC device of the present disclosure may be incorporated into a protection circuit, including active protection components (e.g., integrated circuits or sensors) and passive protective components (e.g. PTCs, negative temperature coefficient (NTC), or fuses) embedded in a core component made of PCB FR-4 material or molding case, and encapsulated with a coating, such as epoxy or encapsulation. The active and passive components are connected with a conductive layer and/or a via hole to form the protection circuit.

In some embodiments, the protection component is selected from the non-limiting group consisting of: fuses, PTCs, NTCs, ICs, sensors, MOSFETS, resistors, and capacitors. Of these protection components, ICs and sensors are considered to be active protection components, while PTCs, NTCs, and fuses are considered to be passive components. In the embodiment shown, the protection component may be a polymeric PTC. It will be appreciated, however, that this arrangement is non-limiting, and the number and configuration of protection components may vary depending on the application.

As will be described below, embodiments of the present disclosure include various advantages over the art. One advantage includes the decrease in device thickness as compared to prior art PTC devices. This is possible by allowing the prevalent current to run orthogonally across the core component, for example, as opposed to through the total thickness of the device. Another advantage is the decoupling of device thickness to electric field strength of the PTC material. This is possible by interdigitating the digits or fingers of the contacts, which allows the device to be 2-D instead of 3-D, such as in the prior art.

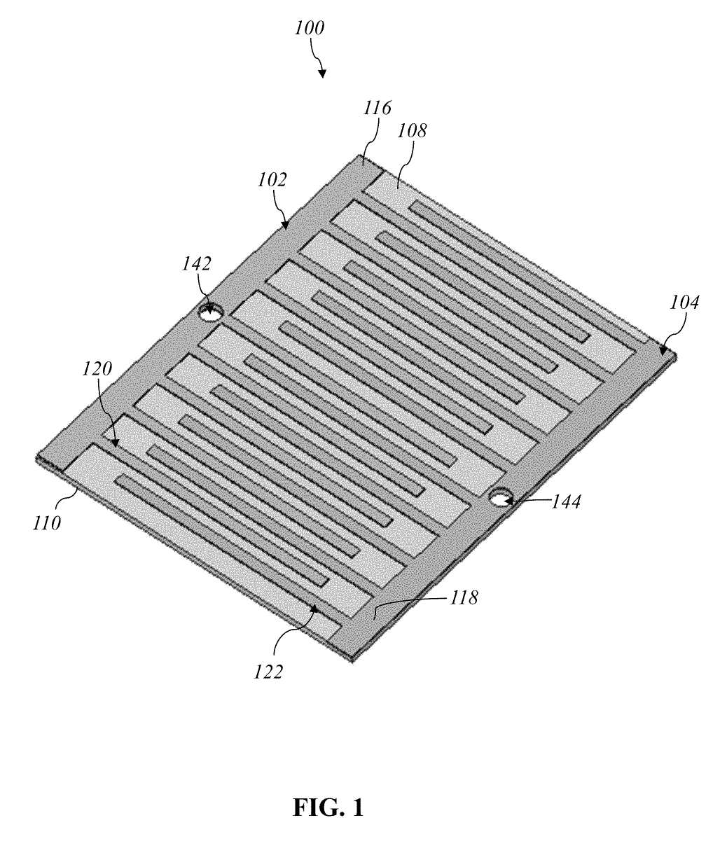

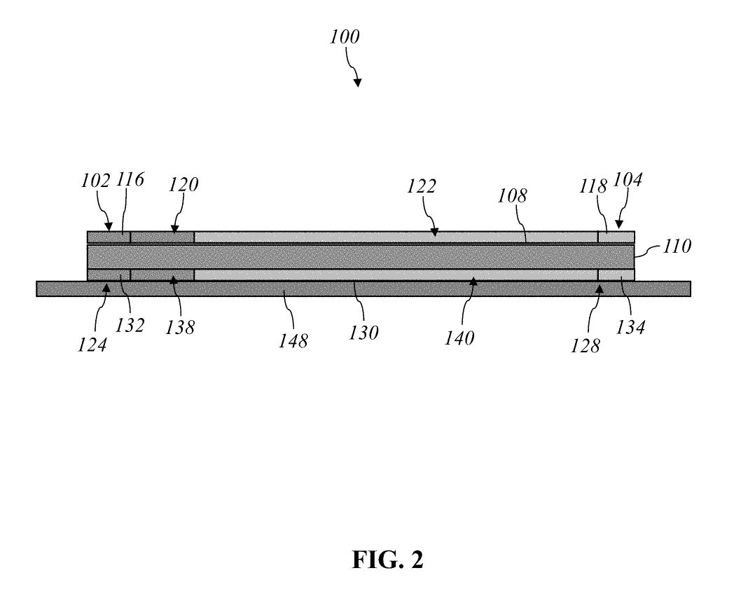

Turning now to FIGS. 1-2, illustrated is an embodiment of an apparatus or device 100 in accordance with the present disclosure. The illustrated device 100 may be located in, for example, a charge/discharge circuit of a secondary cell, and used as a circuit protection device to interrupt an excess current when such current passes through the circuit. As shown, the device 100, which may be a surface mounted PTC device or a polymeric PTC device, includes a first contact 102 and a second contact 104 disposed along a first side 108 of a core component 110. In some embodiments, the core component 110 may be a FR-4 glass-reinforced epoxy laminate, a ceramic, or another moldable/flexible material. The first and second contacts 102, 104 may include respective frame members 116, 118. Extending respectively from frame members 116 and 118 are plurality of digits 120, 122. In some embodiments, the plurality of digits 120, 122 are solid strips of copper extending perpendicularly from frame members 116 and 118, which may also be made of copper or another electrically conductive material.

As shown, the plurality of digits 120 of the first contact 102 are interleaved with the plurality of digits 122 of the second contact 104, for example, in an alternating configuration. In some embodiments, the plurality of digits 120 of the first contact 102 are arranged parallel, or substantially parallel, to the plurality of digits 122 of the second contact 104. Furthermore, each of the plurality of digits 120, 122 extend past one another in opposite directions along a first plane, which is substantially parallel to a second plane defined by the first side (e.g., a top surface) 108 of the core component 110.

In some embodiments, as better shown in FIG. 2, the device 100 further includes a third contact 124 and a fourth contact 128 disposed along a second side 130 of the core component 110. The third and fourth contacts 124, 128 may be the same or similar to the first and second contacts 102, 104 disposed along the first side 108 of the core component 110. As such, the third and fourth contacts 124, 128 may include respective frame members 132, 134. Extending respectively from the frame members 132, 134 are a plurality of digits 138, 140. In some embodiments, the plurality of digits 138, 140 are solid strips of copper extending perpendicularly from frame members 132, 134, which may also be made of copper or another electrically conductive material. The plurality of digits 138 of the third contact 124 are interleaved with the plurality of digits 140 of the fourth contact 128, for example, in an alternating configuration. In some embodiments, the plurality of digits 138 of the third contact 124 are arranged parallel, or substantially parallel, to the plurality of digits 140 of the fourth contact 128. Furthermore, each of the plurality of digits 138, 140 extend past one another in opposite directions along a third plane, which is substantially parallel to a second plane defined by the second first side (e.g., a bottom surface) 130 of the core component 110.

In some embodiments, the first contact 102 may be electrically connected with the third contact 124 using a first via 142, while the second contact 104 may be electrically connected with the fourth contact 128 using a second via 144. In some embodiments, the third and fourth contacts 124, 128 are formed directly atop a substrate 148, such as a printed circuit board (PCB). In other embodiments, the core component 110 is directly coupled to the substrate 148, for example, in the case the third and fourth contacts 124, 128 are not present. In some embodiments, the substrate may be a flexible polymer substrate having stable dimensions under a given temperature that causes PTC change. For example, for ethylene vinyl acetate (EVA), it could be PET or polypropylene PTC with PFA substrate, or PTC with PVDF and a polyimide substrate.

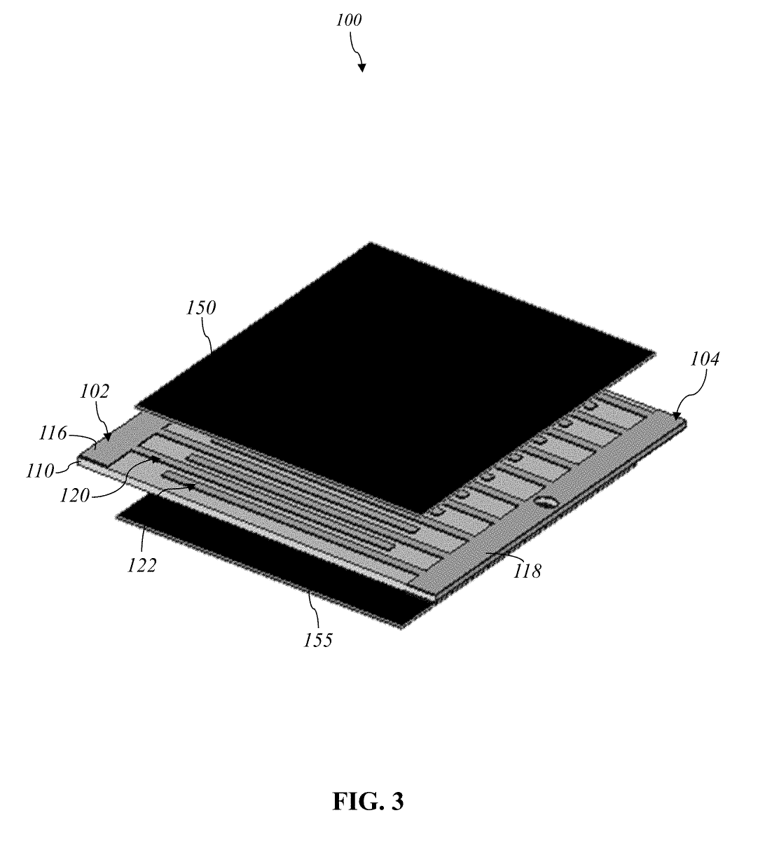

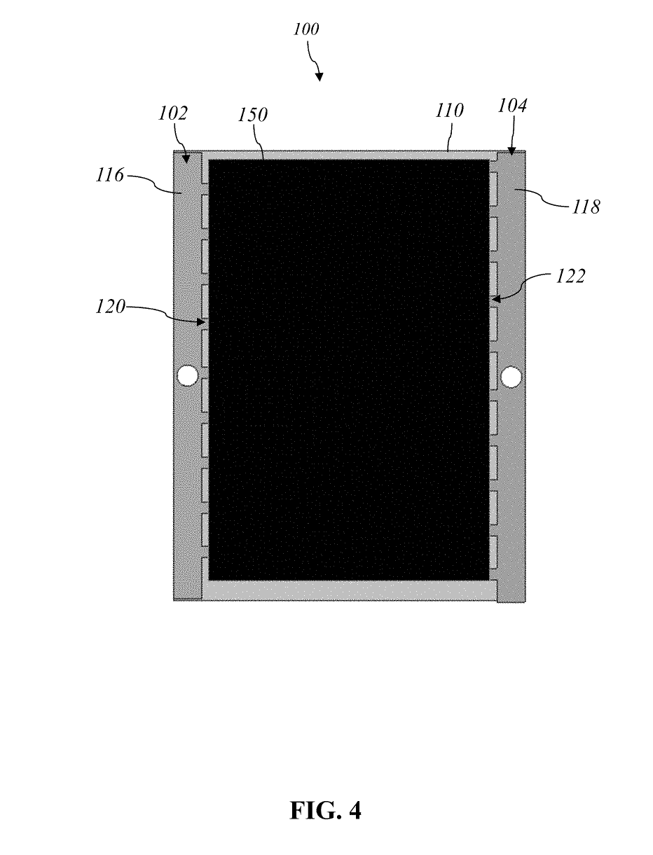

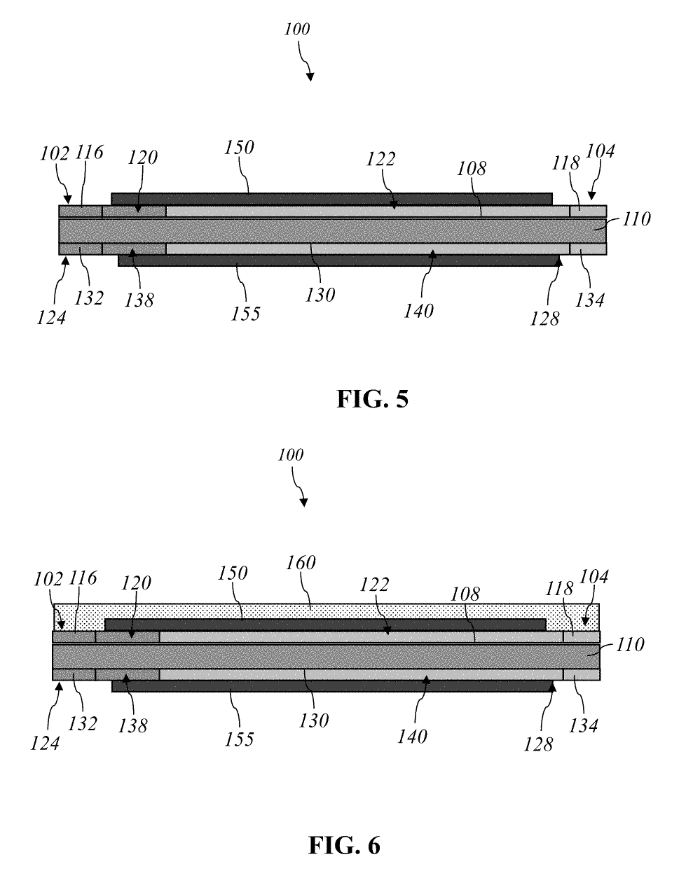

Turning now to FIGS. 3-5, a polymeric PTC (PPTC) material layer in accordance with the present disclosure will be described in greater detail. As shown, the device 100 may further include a first PPTC material layer 150 formed over the first and second contacts 102, 104. The first PPTC material layer 150 may be disposed over the plurality of digits 120 and 122, wherein the first PPTC material layer 150 does not extend over the frames 116, 118 of the first and second contacts 102, 104. Similarly, the device 100 may further include a second PPTC material layer 155 formed over the third and fourth contacts 124, 128. The second PPTC material layer 155 may be disposed over the plurality of digits 138 and 140, wherein the second PPTC material layer 155 does not extend over the frames 132, 134 of the first and second contacts 116, 118. In some embodiments, the first and second PPTC material layers 150, 155 may be the same or different sizes/dimensions.

The PPTC material layers 150, 155 may correspond to a material that exhibits non-linear changes in resistance with changes in temperature such as 125° C., 165° C., 180° C., or other, or a different material with similar characteristics. For example, the PPTC material layers 150, 155 may be made of a positive temperature coefficient conductive composition comprising a polymer and a conductive filler. In some embodiments, the polymer of the PPTC material layers 150, 155 may be a crystalline polymer selected from the group consisting of polyethylene, polypropylene, polyoctylene, polyvinylidene chloride and a mixture thereof, or a semi-crystalline polymer such as polyvinylidene difluoride, polyethylene, ethylene tetrafluoroethylene, ethylene-vinyl acetate, ethylene butyl acrylate or different materials having similar characteristics and a mixture thereof. The conductive filler may be dispersed in the polymer and is selected from the group consisting of carbon black, metal powder, conductive ceramic powder and a mixture thereof. Furthermore, to improve sensitivity and physical properties of the PTC material, the PTC conductive composition may also include an additive, such as a photo initiator, cross-link agent, coupling agent, dispersing agent, stabilizer, anti-oxidant and/or nonconductive anti-arcing filler. In some embodiments, the PPTC material layers 150, 155 are applied as layers of PPTC ink.

Turning now to FIG. 6, the device 100 may further include a bonding layer 160 disposed over the first PPTC material layer 150 in some embodiments. The bonding layer 160 may be an encapsulating material that surrounds part or all of the various layers that form the device 100. The encapsulating material may correspond to a material with a high dielectric constant capable of withstanding the environmental conditions in which the device is intended to operate. For example, the encapsulating material may correspond to plastic, polyphenylene sulfide, liquid crystal polymer, polyimide, polytetrafluroethylene, or a different material with similar characteristics.

As shown, the bonding layer 160 conforms to an upper surface of the first PPTC material layer 150, as well as to the frame members 116, 118 of the first and second contacts 102, 104. In other embodiments, the bonding layer 160 also encloses the core component 110. The bonding layer 160 may be one or more layers of epoxy formed atop the layers of the device 100, for example, by injection molding. Although not shown, in other embodiments, a bonding layer may also be disposed around the second PPTC material layer 155.

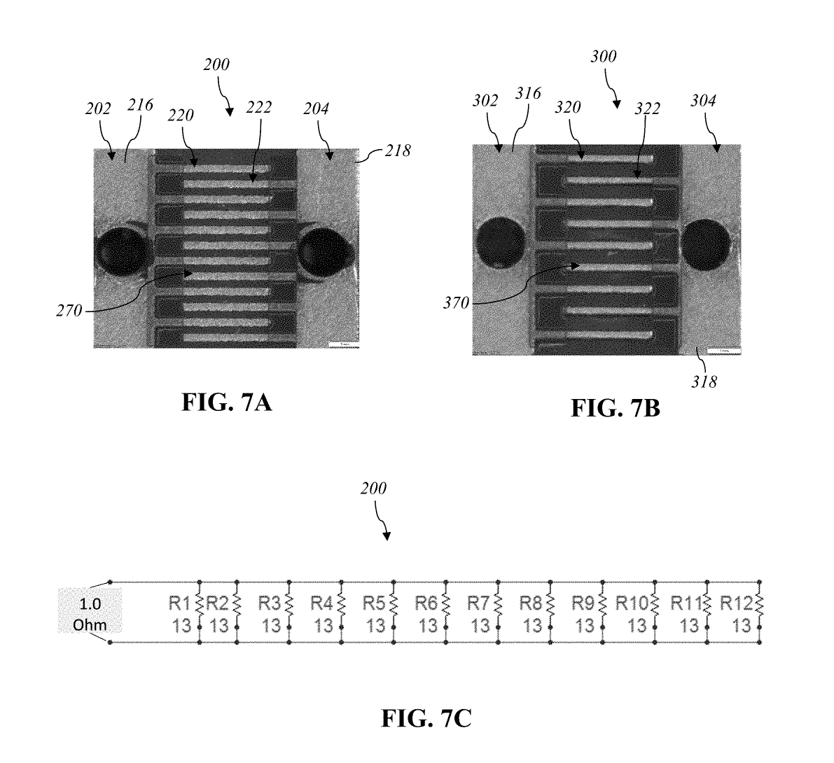

Turning now to FIGS. 7A-C, example devices 200, 300 will be described in greater detail. As shown, devices 200, 300 may be surface mounted PTC devices including many or all of the features previously described above in relation to the device 100. As such, only certain aspects of the devices 200, 300 will hereinafter be described for the sake of brevity. As shown, the device 200 includes first and second contacts 202, 204 having, respectively, interdigitated or interleaved digits 220, 222 extending perpendicularly from frame members 216 and 218. In this embodiment, a total of 12 digits are present in a PPTC active area 270.

Similarly, the device 300 includes first and second contacts 302, 304 having, respectively, interdigitated or interleaved digits 320, 322 extending perpendicularly from frame members 316 and 318. In this embodiment, a total of 8 digits are present in a PPTC active area 370. Comparing the device 200 to the device 300, it can be seen that the distance between each digit in PPTC active area 270 is less than the distance between each digit in PPTC active area 370. As the distance between digits decreases, so does overall device resistance. This is due to the division of resistance across multiple paths. For example, FIG. 7C, which schematically represents a portion of the device 200, demonstrates division of resistance across 12 digits (e.g., R1-R12). It will be appreciated that fewer or more digits may be provided to adjust the resistance as desired.

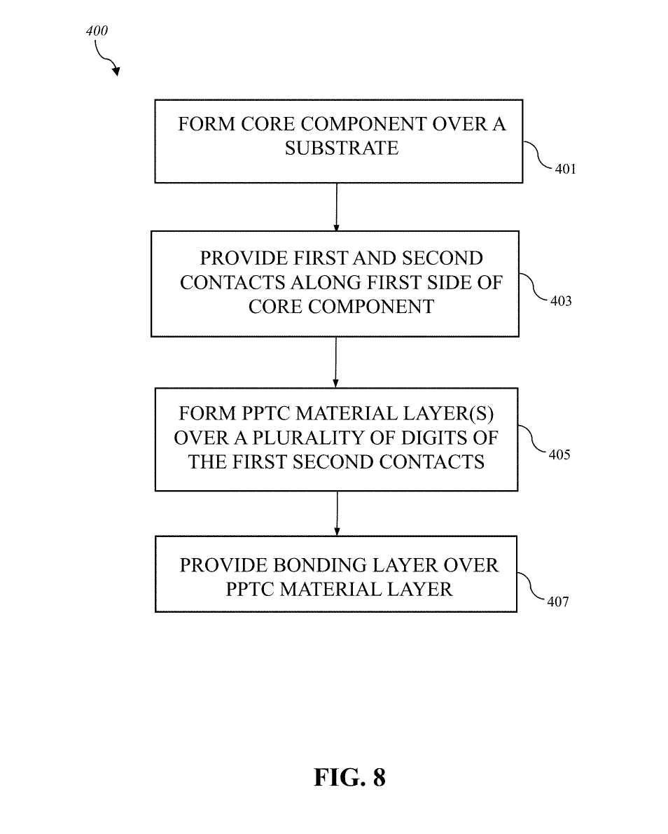

Turning now to FIG. 8, a method or process flow 400 for forming a surface mounted PTC device, such as device 100, 200, and/or 300, will be described in greater detail. At 401, a core component is formed over a substrate. In some embodiments, the substrate is a PCB. In some embodiments, the core component is made of a FR-4 glass-reinforced epoxy laminate, a ceramic, or another moldable/flexible material. In some embodiments, a set of contacts is first formed directly atop the substrate prior to the core component being formed. In some embodiments, the PTC device can be deposited on planar, tubular and/or multi surface substrates.

At 403, a first contact and a second contact may be formed along a first side of the core component. In some embodiments, each of the first and second contacts includes a frame member, and a plurality of digits extending from the frame member, wherein the plurality of digits of the first contact are interleaved with the plurality of digits of the second contact. In some embodiments, the plurality of digits of the first contact and the plurality of digits of the second contact are arranged substantially parallel to one another, wherein the plurality of digits of the first and the plurality of digits of the second contact extend along a first plane parallel, or substantially parallel, to the top surface of the core component. In some embodiments, the interdigital fingers can be deposited by screen printing, electroplating, electroless deposition, gravure deposition, sputtering, decal, etc.

At 405, one or more polymer PPTC material layers may be formed over the plurality of digits of the first and second contacts. In some embodiments, The PPTC material layers may be have a positive temperature coefficient conductive composition comprising a polymer and a conductive filler. In some embodiments, the polymer of the PTC material layers may be a crystalline polymer selected from the group consisting of polyethylene, polypropylene, polyoctylene, polyvinylidene chloride and a mixture thereof, or a semi-crystalline polymer such as polyvinylidene difluoride, polyethylene, ethylene tetrafluoroethylene, ethylene-vinyl acetate, ethylene butyl acrylate or different materials having similar characteristics and a mixture thereof The conductive filler may be dispersed in the polymer and is selected from the group consisting of carbon black, metal powder, conductive ceramic powder and a mixture thereof. In some embodiments, the particle size of the powders and the filler by volume can be optimized. For example, a volume fraction of filler may be approximately 10% to 70%. Furthermore, to improve sensitivity and physical properties of the PTC material, the PTC conductive composition may also include an additive, such as a photo initiator, cross-link agent, coupling agent, dispersing agent, stabilizer, anti-oxidant and/or nonconductive anti-arcing filler. In some embodiments, the PPTC material layers is applied as layers of PPTC ink through a screen with emulsion. In some embodiments, the PPTC material layers could be thick-film technique deposited (e.g., screen printed EPD electrophoretic deposition or sprayed etc., or laminated, doctor bladed, gravure coated etc.)

At 407, one or more bonding layer may be provided over the PPTC material layer. In some embodiments, the bonding layer may be a conformal layer of epoxy, which adheres to the exposed surfaces of the device. In some embodiments, the bonding layer is deposited via injection molding.

While the present disclosure has been described with reference to certain approaches, numerous modifications, alterations and changes to the described approaches are possible without departing from the sphere and scope of the present disclosure, as defined in the appended claims. Accordingly, it is intended that the present disclosure not be limited to the described approaches, but that it has the full scope defined by the language of the following claims, and equivalents thereof. While the disclosure has been described with reference to certain approaches, numerous modifications, alterations and changes to the described approaches are possible without departing from the spirit and scope of the disclosure, as defined in the appended claims. Accordingly, it is intended that the present disclosure not be limited to the described approaches, but that it has the full scope defined by the language of the following claims, and equivalents thereof.

1. A surface mounted device, comprising:
a core component; and
a first contact and a second contact disposed along a first side of the core component, each of the first and second contacts including:
a frame member; and
a plurality of digits extending from the frame member,
wherein the plurality of digits of the first contact are interleaved with the plurality of digits of the second contact.

2. The surface mounted device of claim 1, wherein the plurality of digits of the first contact and the plurality of digits of the second contact are arranged substantially parallel to one another.

3. The surface mounted device of claim 1, wherein the plurality of digits of the first contact and the plurality of digits of the second contact extend along a first plane.

4. The surface mounted device of claim 3, wherein the first plane is substantially parallel to a second plane defined by a top surface of the core component.

5. The surface mounted device of claim 1, further comprising a via formed through the frame member of each of the first and second contacts.

6. The surface mounted device of claim 1, further comprising a third contact and a fourth contact disposed along a second side of the core component, each of the third and fourth contacts including:
a frame member; and
a plurality of digits extending from the frame member,
wherein the plurality of digits of the third contact are interleaved with the plurality of digits of the fourth contact.

7. The surface mounted device of claim 1, further comprising a polymer positive temperature coefficient (PPTC) material layer disposed atop the plurality of digits of the first and second contacts.

8. The surface mounted device of claim 7, further comprising a bonding layer disposed over the PPTC material layer.

9. The surface mounted device of claim 7, wherein the PPTC material layer does not extend over the frame of the first and second contacts.

10. The surface mounted device of claim 1, wherein the core component is a FR-4 glass-reinforced epoxy laminate or a ceramic.

11. A positive temperature coefficient (PTC) device, comprising:
a core component; and
a first contact and a second contact disposed along a first side of the core component, each of the first and second contacts including:
a frame member; and
a plurality of digits extending substantially perpendicularly from the frame member,
wherein the plurality of digits of the first contact are interleaved with the plurality of digits of the second contact.

12. The PTC device of claim 11, wherein the plurality of digits of the first contact and the plurality of digits of the second contact are arranged substantially parallel to one another, and wherein the plurality of digits of the first contact and the plurality of digits of the second contact extend along a first plane.

13. The PTC device of claim 12, wherein the first plane is substantially parallel to a second plane defined by the first side of the core component.

14. The PTC device of claim 11, further comprising a via provided through the frame member of each of the first and second contacts.

15. The PTC device of claim 11, further comprising a third contact and a fourth contact disposed along a second side of the core component, each of the third and fourth contacts including:
a frame member; and
a plurality of digits extending from the frame member,
wherein the plurality of digits of the third contact are interleaved with the plurality of digits of the fourth contact.

16. The PTC device of claim 11, further comprising a polymer positive temperature coefficient (PPTC) material layer disposed atop the plurality of digits of the first and second contacts.

17. The PTC device of claim 16, further comprising a bonding layer disposed over the PPTC material layer.

18. A method for forming a surface mounted device, the method comprising:
providing a core component on a substrate; and
providing a first contact and a second contact along a first side of the core component, each of the first and second contacts including:
a frame member; and
a plurality of digits extending from the frame member,
wherein the plurality of digits of the first contact are interleaved with the plurality of digits of the second contact.

19. The method of claim 18, further comprising arranging the plurality of digits of the first contact substantially parallel to the plurality of digits of the second contact, wherein the plurality of digits of the first contact and the plurality of digits of the second contact extend along a first plane.

20. The method of claim 18, further comprising forming a polymer positive temperature coefficient (PPTC) material layer over the plurality of digits of the first and second contacts.
